(19) United States
(12) Patent Application Publication
(10) Pub. No.: US 2025/0388228 A1
(43) Pub. Date: Dec. 25, 2025

(54) UPDATE INFORMATION NOTIFICATION DEVICE, VEHICLE SYSTEM, AND STORAGE MEDIUM STORING UPDATE INFORMATION NOTIFICATION PROGRAM

(71) Applicant: DENSO CORPORATION, Kariya-city (JP)

(72) Inventors: Koichi TAKAGI, Kariya-city (JP); Toshiaki HORAI, Kariya-city (JP); Shiori MANEYAMA, Kariya-city (JP)

(21) Appl. No.: 19/311,179

(22) Filed: Aug. 27, 2025

Related U.S. Application Data
(63) Continuation of application No. PCT/JP2024/007821, filed on Mar. 1, 2024.

(30) Foreign Application Priority Data
Mar. 29, 2023 (JP) 2023-053436

(51) Int. Cl. B60W 50/14; B60K 35/28; B60W 40/08; G06F 8/65

(52) U.S. Cl. CPC B60W 50/14; B60K 35/28; B60W 40/08; G06F 8/65; B60K 2360/119; B60K 2360/1876; B60W 2050/146

(57) ABSTRACT

An update information notification device causes a notification device to notify update information related to a software update when software of an electronic control device to be updated is updated by update software acquired from a distribution device. The update information notification device is configured to acquire the update information, specify an occupant state indicating a state of an occupant, specify a vehicle state indicating a state of a vehicle, and determine a notification mode of the update information and cause the notification device to notify the update information in accordance with a determined notification mode. The update information notification device determines a notification mode of the update information based on a case classified according to a combination of the specified occupant state and the specified vehicle state.

### CROSS REFERENCE TO RELATED APPLICATION

The present application is a continuation application of International Patent Application No. PCT/JP2024/007821 filed on Mar. 1, 2024 which designated the U.S. and claims the benefit of priority from Japanese Patent Application No. 2023-053436 filed on Mar. 29, 2023. The entire disclosures of all of the above applications are incorporated herein by reference.

### TECHNICAL FIELD

The present disclosure relates to an update information notification device, a vehicle system, and an update information notification program.

### BACKGROUND

A related art discloses a method of differentiating notification to a driver or the like on the basis of the feature of update software as a configuration of notifying the driver or the like of update information related to a software update.

### SUMMARY

According to an aspect of the present disclosure, an update information notification device that causes a notification device to notify update information related to a software update when software of an electronic control device to be updated is updated by update software acquired from a distribution device is provided. The update information notification device includes at least one of (i) a circuit and (ii) a processor with a memory storing computer program code executable by the processor, the at least one of the circuit and the processor configured to cause the update information notification device to: acquire the update information; specify an occupant state indicating a state of an occupant; specify a vehicle state indicating a state of a vehicle; and determine a notification mode of the update information and cause the notification device to notify the update information in accordance with a determined notification mode. A notification mode of the update information may be determined based on a case classified according to a combination of a specified occupant state and a specified vehicle state.

### BRIEF DESCRIPTION OF DRAWINGS

Objects, features and advantages of the present disclosure will become more apparent from the following detailed description made with reference to the accompanying drawings. In the drawings:

FIG. 1 is a functional block diagram illustrating an overall configuration of an embodiment;

FIG. 2 is a functional block diagram of an HCU;

FIG. 3 is a diagram illustrating a case classification table;

FIG. 4 is a diagram illustrating the content of a display mode;

FIG. 5 is a diagram illustrating the content of the display mode;

FIG. 6 is a diagram illustrating the content of the display mode;

FIG. 7 is a diagram illustrating the content of the display mode;

FIG. 8 is a diagram illustrating the content of the display mode;

FIG. 9 is a diagram illustrating the content of the display mode;

FIG. 10 is a diagram illustrating a display pattern table;

FIG. 11 is a diagram illustrating a display pattern;

FIG. 12 is a diagram illustrating the display pattern;

FIG. 13 is a diagram for explaining a display priority;

FIG. 14 is a diagram for explaining an operation priority;

FIG. 15 is a diagram for explaining a displayed information amount;

FIG. 16 is a flowchart illustrating processing of determining reception of an update information notification signal;

FIG. 17 is a flowchart illustrating processing of determining reception of an error information notification signal;

FIG. 18 is a flowchart illustrating processing of determining an operation of a simple display request;

FIG. 19 is a diagram for explaining switching to a simple display;

FIG. 20 is a diagram for explaining switching to the simple display;

FIG. 21 is a diagram for explaining switching to the simple display;

FIG. 22 is a diagram for explaining a display of a meter device;

FIG. 23 is a flowchart illustrating processing of determining an operation of a detailed display request;

FIG. 24 is a diagram for explaining a display of the reason why switching to the detailed display is impossible;

FIG. 25 is a diagram for explaining switching to the detailed display;

FIG. 26 is a flowchart illustrating processing of determining an operation of a cancel request;

FIG. 27 is a diagram for explaining a display of a message indicating the reason why the cancel request is discarded;

FIG. 28 is a diagram for explaining a display of cancel information;

FIG. 29 is a diagram for explaining the display of the cancel information;

FIG. 30 is a flowchart illustrating processing of determining an update information display request when a vehicle power supply is turned off; and

FIG. 31 is a flowchart illustrating processing of determining whether the vehicle power supply is turned off during a software update.

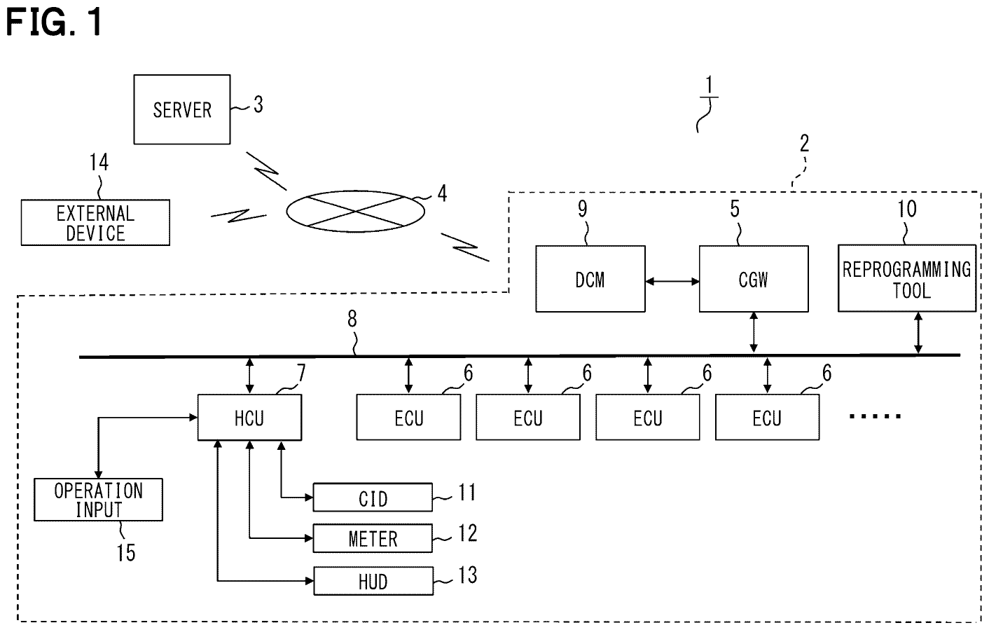

### DETAILED DESCRIPTION

For example, there is provided a technique of updating software of an in-vehicle electronic control device (hereinafter, referred to as “electronic control unit (ECU)”) for the purpose of improving functions, fixing bugs, and the like. In this technique, the server distributes update software to a software update apparatus, and the software update apparatus transmits the update software to an update target ECU, thereby updating the software of the update target ECU. In the software update, a campaign notification phase of recommending the software update to a driver, a download phase in which the software update apparatus acquires the update software from the server, an installation phase in which the update target ECU writes the update software to a storage area, and an activation phase in which the update target ECU activates the update software are sequentially performed. In this case, the driver or the like is notified of update information related to the software update by displaying the update information on, for example, an in-vehicle display device or a portable information terminal.

There are various scenes in which the software update is performed, and the scenes are classified into a large number of scenes. For example, there is a case where update information is notified while the vehicle is traveling or parked. In a case where the update information is notified while the vehicle is traveling, there is a possibility that the update information is notified in a situation where the driver is driving, and there is a possibility that the driver's attention is attracted depending on a notification timing and an information amount. On the other hand, in a case where the update information is notified during parking, there is a possibility that the update information is notified in a situation where there is no occupant in the vehicle, and there is a possibility that the electric power of the vehicle battery is unnecessarily consumed. Because of such circumstances, it is required to appropriately notify the update information depending on scenes.

The present disclosure provides a technique that appropriately notifies update information related to a software update depending on scenes.

According to one aspect of the present disclosure, an update information notification device causes a notification device to notify update information related to a software update when software of an electronic control device to be updated is updated by update software acquired from a distribution device. The update information notification device includes: an update information acquisition section configured to acquire the update information; an occupant state specifying section configured to specify an occupant state indicating a state of an occupant; a vehicle state specifying section configured to specify a vehicle state indicating a state of a vehicle; and a notification control section configured to determine a notification mode of the update information and cause the notification device to notify the update information in accordance with a determined notification mode. The notification control section determines a notification mode of the update information based on a case classified according to a combination of the occupant state specified by the occupant state specifying section and the vehicle state specified by the vehicle state specifying section.

The notification mode of the update information is determined on the basis of the specification result of the occupant state and the specification result of the vehicle state, and the update information is displayed in accordance with the determined notification mode. The update information is not notified in a uniform notification mode of the update information, but the update information is notified by determining the notification mode of the update information on the basis of the occupant state and the vehicle state, so that the update information related to the software update can be appropriately notified depending on scenes.

For example, in a case where the update information is notified while the vehicle is traveling, there is a possibility that the driver's attention is attracted if the update information is notified in a detailed notification mode. However, by reducing the information amount and notifying the update information in a simple notification mode, the attraction of the driver's attention can be avoided in advance. For example, in a case where the update information is notified during parking, if the information amount is increased and the update information is notified in a detailed notification mode, there is a possibility that electric power of the vehicle battery is unnecessarily consumed. However, by notifying the update information in the simple notification mode, unnecessary electric power consumption of the vehicle battery can be avoided in advance.

An embodiment will be described below with reference to the drawings. A software update system 1 is configured such that a vehicle system 2 mounted on a vehicle and a server 3 (corresponding to “distribution device”) functioning as an OTA (Over The Air) center can perform data communication via a communication network 4. The vehicle system 2 is configured such that a software update apparatus (hereinafter, referred to as “central gateway (CGW)”) 5 functioning as an OTA master, a large number of ECUs 6, and a human machine interface (HMI) control unit (hereinafter, referred to as “HMI control unit (HCU)”) 7 (corresponding to “update information notification device”) can perform data communication via an in-vehicle network 8.

The in-vehicle network 8 is, for example, a controller area network (CAN) (registered trademark). The in-vehicle network 8 may be FLEXRAY (registered trademark), Clock Extension Peripheral Interface (CXPI) (registered trademark), Ethernet (registered trademark), or the like. The present embodiment exemplifies a configuration in which four ECUs 6 are connected to the in-vehicle network 8, but the number of ECUs 6 connected to the in-vehicle network 8 is arbitrary. The number of in-vehicle networks 8 is also arbitrary.

The ECU 6 is, for example, a device that controls a drive system, a device that controls an advanced driving assistant system (ADAS) system, a device that controls a multimedia system, or the like, and can serve as an update target ECU 6 that is a software update target by software modification, function improvement, or the like. In addition to a so-called program commanding a processing procedure for causing a computer to perform an operation, the software includes a file, data, a library, and the like referred to in executing the program. As types of the ECU 6, there are an ECU including a double-sided memory having two software storage areas and an ECU including a single-sided memory having one software storage area depending on the configuration of the software storage area. The double-sided memory may be referred to as a dual-bank memory, and the single-sided memory may be referred to as a single-bank memory. In addition, the HCU 7 can also be a software update target.

An in-vehicle communication device (hereinafter, referred to as “data communication module (DCM)”) 9 is connected to the CGW 5. The DCM 9 can receive an update package distributed from the server 3 by wirelessly connecting to the server 3 via the communication network 4. The update package distributed from the server 3 includes specification data capable of specifying the update target ECU 6 and update software to be written in the update target ECU 6. The update software corresponds to so-called all data in a case where the software is entirely rewritten, and corresponds to so-called difference data in a case where the software is partially rewritten. When acquiring the update package distributed from the server 3, the DCM 9 transfers the acquired update package to the CGW 5.

When the update package is transferred from the DCM 9, the CGW 5 extracts the specification data and the update software from the transferred update package, specifies the update target ECU 6 from the extracted specification data, transmits the extracted update software to the update target ECU 6 and transmits an update instruction to the update target ECU 6, and causes the update target ECU 6 to update the software. That is, the update target ECU 6 receives the update software from the CGW 5, receives the update instruction, and writes the update software to the storage area to update the software. The mode in which the update software acquired from the server 3 via the communication network 4 is written to the update target ECU 6 is referred to as so-called “wireless reprogramming”. The present embodiment exemplifies a configuration in which the DCM 9 is disposed separately from the CGW 5, but the function of the DCM 9 may be incorporated in the CGW 5.

A reprogramming tool 10 (corresponding to “distribution device”) is detachably connected to the in-vehicle network 8. The reprogramming tool 10 distributes the update software to the update target ECU 6 and transmits an update instruction to the update target ECU 6 while being connected to the in-vehicle network 8, and causes the update target ECU 6 to update the software. That is, the update target ECU 6 receives the update software from the reprogramming tool 10, receives the update instruction, and writes the update software to the storage area to update the software. The mode in which the update software acquired from the reprogramming tool 10 not via the communication network 4 is written to the update target ECU 6 is referred to as so-called “wired reprogramming”. The present embodiment exemplifies a configuration in which the reprogramming tool 10 is directly connected to the in-vehicle network 8, but the reprogramming tool 10 may be connected to the in-vehicle network 8 via the CGW 5.

Software update phases include a campaign notification phase in which the server 3 recommends the vehicle system 2 to update software, a download phase in which the CGW 5 acquires an update package from the server 3, an installation phase in which the update target ECU 6 writes the update software to the storage area when the CGW 5 instructs the update target ECU 6 to write the update software, and an activation phase in which the target ECU 6 activates the update software when the CGW 5 instructs the update target ECU 6 to activate the update software. When the driver appropriately accepts each phase, each phase progresses. The CGW 5 manages the status of the software update in each of the campaign notification, download, installation, and activation phases, and transmits an update information notification signal indicating the update status to the HCU 7.

The update information is various information related to a software update, and includes information capable of specifying the status of progress of the software update, a function to be restricted in use during the software update, and the like. For example, in the campaign notification phase, the update information includes the file name, file size, function description, and the like of the update software. For example, in the download phase, the update information includes information indicating the start of download, information indicating the execution of download, information such as a numerical value indicating, in percentage, the amount of data that has been downloaded with respect to the amount of data scheduled to be downloaded as the progress of download, information notifying the reason for suspension when download is suspended for some reason, information indicating the completion of download, and the like. For example, in the installation phase, the update information includes information indicating the start of installation, information indicating the execution of installation, information such as a numerical value indicating, in percentage, the amount of data that has been installed with respect to the amount of data scheduled to be installed as the progress of installation, information notifying the reason for suspension when installation is suspended for some reason, information indicating the completion of installation, and the like. For example, in the activation phase, the update information includes information indicating the start of activation, information indicating the execution of activation, information such as a numerical value indicating, in percentage, the amount of data that has been activated with respect to the amount of data scheduled to be activated as the progress of activation, information notifying the reason for suspension when activation is suspended for some reason, information indicating the completion of activation, and the like. For example, when software related to travel control is being updated, the update information includes information capable of specifying a function or the like to be restricted in use related to the travel control.

The CGW 5 transmits the update information notification signal to the HCU 7 at a predetermined cycle. When an error occurs in the software update, the CGW 5 transmits an error information notification signal to the HCU 7 by interruption.

A center information display (hereinafter, referred to as “center information display (CID)”) 11 (corresponding to “notification device”), a meter device 12 (corresponding to “notification device”), and a head-up display (hereinafter, referred to as “head-up display (HUD)”) 13 (corresponding to “notification device”) are connected to the HCU 7. The CID is disposed in front of the driver's seat and displays, for example, a map used for a navigation function, a camera image from a parking assist function, audio information related to audio, air conditioning information related to air conditioning, and the like. The meter device 12 is disposed in front of the driver's seat, includes various indicators, and displays a vehicle speed, a shift position, the remaining amount of fuel, a warning, and the like. The HUD 13 projects information such as a vehicle speed, a shift position, and route guidance on the windshield as a virtual image in front of the driver's seat. An external device 14 can perform data communication with the vehicle system 2 by wirelessly connecting to the DCM 9 via the communication network 4. The external device 14 is a portable information terminal such as a smartphone or a tablet terminal that can be carried by the occupant, and is a terminal that can be used by the occupant outside the vehicle.

At the time of the software update, when the HCU 7 receives the update information notification signal from the CGW 5, the HCU 7 can display the update information based on the update information notification signal on the CID 11 or the meter device 12. The case of displaying the update information on the meter device 12 includes notification of the update information by any of turning on, blinking, and turning off the indicator. In a situation where the external device 14 and the DCM 9 are wirelessly connected via the communication network 4 and the external device 14 and the vehicle system 2 can perform data communication, at the time of the software update, when the HCU 7 receives the update information notification signal from the CGW 5, the HCU 7 can display the update information based on the update information notification signal on the external device 14.

By the update information being displayed on the CID 11 or the meter device 12, the occupant can check various information related to the software update in the vehicle. By the update information being displayed on the external device 14 in a situation where the occupant uses the external device 14 outside the vehicle, the occupant can check various information related to the software update outside the vehicle. The present embodiment exemplifies a configuration in which the update information is displayed on the CID 11, the meter device 12, and the external device 14, but the update information may be displayed on the HUD 13.

An operation input portion 15 to which the occupant can perform an operation input is connected to the HCU 7. The operation input portion 15 is, for example, a touch panel of the CID 11, a touch panel of the external device 14, a steering switch disposed on a steering, or the like. When detecting the occupant's operation input, the operation input portion 15 transmits an operation input detection signal to the HCU 7. The occupant can perform an operation input to the update information by the operation input portion 15. For example, when an acceptance screen asking for acceptance of download is displayed after the campaign notification, an operation input as to whether or not to accept download can be performed. For example, when an acceptance screen asking for acceptance of installation is displayed after the download, an operation input as to whether or not to accept installation can be performed. For example, when an acceptance screen asking for acceptance of activation is displayed after installation, an operation input as to whether or not to accept activation can be performed.

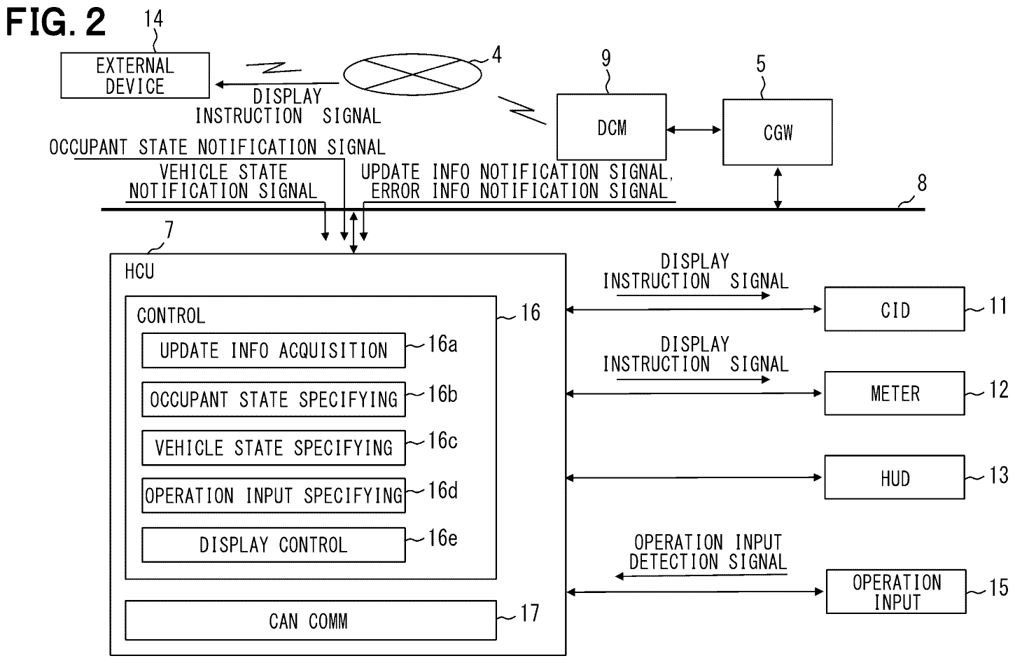

As illustrated in FIG. 2, the HCU 7 includes a control section 16 and a CAN communication section 17. The control section 16 is mainly configured with a microcomputer including a central processing unit (CPU), a read only memory (ROM), a random access memory (RAM), an input/output (I/O), and the like. The control section 16 executes a control program stored in a non-transitory tangible storage medium to perform processing corresponding to the control program, and controls the overall operation of the HCU 7. The CAN communication section 17 controls transmission and reception of CAN signals to and from the in-vehicle network 8. The HCU 7 is connected to a battery power supply (+B) supplied from a vehicle battery, and can operate even in a case where the vehicle power supply is turned off.

The control section 16 includes an update information acquisition section 16a, an occupant state specifying section 16b, a vehicle state specifying section 16c, an operation input specifying section 16d, and a display control section 16e (corresponding to “notification control section”). These sections 16a to 16e execute an update information notification program.

When receiving an update information notification signal from the CGW 5, the update information acquisition section 16a acquires update information on the basis of the received update information notification signal.

The occupant state specifying section 16b specifies an occupant state indicating the state of the occupant. When receiving occupant state notification signals indicating, for example, an analysis result of an image captured by an image sensor that captures the inside of the vehicle, a detection result of a seat sensor that detects seating, a detection result of a seat belt sensor that detects wearing of a seat belt, a detection result of a biometric sensor that detects a living body, and the like, the occupant state specifying section 16b specifies the occupant state on the basis of the received occupant state notification signal. The occupant state specifying section 16b specifies, as the occupant state, for example, whether the occupant is only a driver, whether the occupants are a driver and a passenger, whether the occupant is only a passenger, whether there is no occupant in the vehicle, whether the occupant gets on the vehicle, whether the occupant gets off the vehicle, and the like.

The vehicle state specifying section 16c specifies a vehicle state indicating the state of the vehicle. When receiving vehicle state notification signals indicating, for example, an on and off state of an ignition signal, an on and off state of an accessory signal, an on and off state of an automated driving function, and the like, the vehicle state specifying section 16c specifies the vehicle state on the basis of the received vehicle state notification signal. The vehicle state specifying section 16c specifies, as the vehicle state, for example, whether the vehicle is traveling, stopped, or parked, whether the vehicle is in automated driving or manual driving, and the like. The present embodiment exemplifies a configuration in which an engine vehicle is assumed, and whether the vehicle is traveling or parked is specified by the on and off state of the ignition signal. However, in a case where an electric vehicle is assumed, whether the vehicle is traveling or parked may be specified by the on and off state of an electric vehicle (EV) system.

The operation input specifying section 16d specifies an occupant's operation input. When receiving the operation input detection signal from the operation input portion 15, the operation input specifying section 16d specifies the occupant's operation input on the basis of the received operation input detection signal.

The display control section 16e determines the display mode of the update information on the basis of the specification result of the occupant state specifying section 16b, the specification result of the vehicle state specifying section 16c, and the specification result of the operation input specifying section 16d described above. That is, the display control section 16e does not display the update information in a uniform display mode, but displays the update information in different display modes depending on the occupant state, the vehicle state, and the situation of the occupant's operation input. When determining the display mode of the update information, the display control section 16e transmits a display instruction signal to the CID 11 and the meter device 12, and causes the CID 11 and the meter device 12 to display the update information in accordance with the determined display mode. If the vehicle system 2 and the external device 14 can perform data communication, when determining the display mode of the update information, the display control section 16e causes the DCM 9 to transmit the display instruction signal to the external device 14, and causes the external device 14 to display the update information in accordance with the determined display mode.

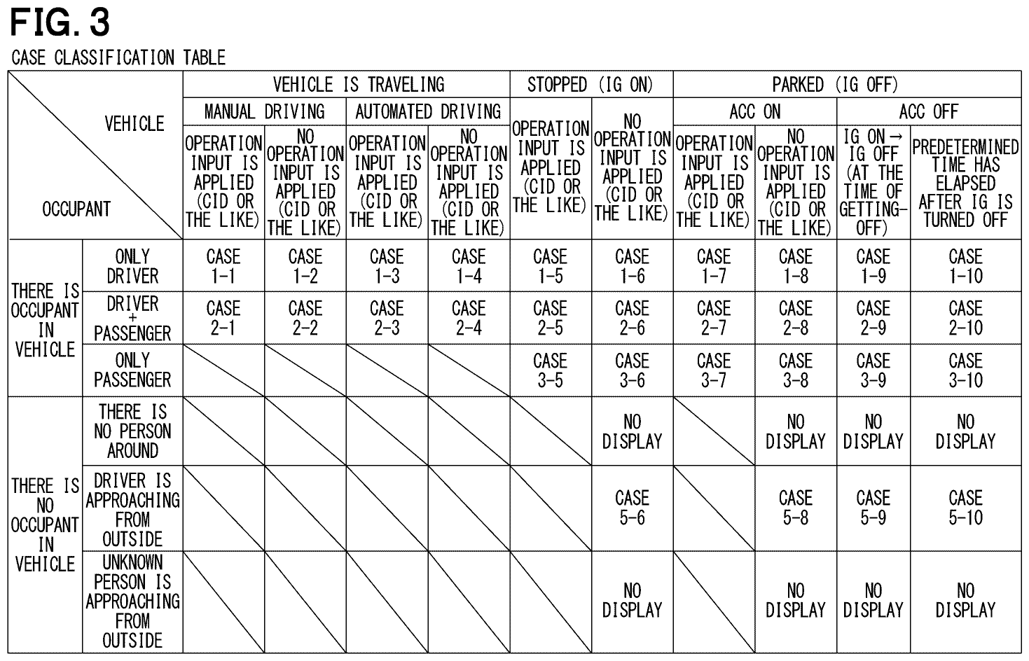

The display mode of the update information will be described. As illustrated in FIG. 3, the display control section 16e has a case classification table in which cases are classified on the basis of the occupant state, the vehicle state, and the occupant's operation input. The display control section 16e specifies the corresponding case on the basis of the specification result of the occupant state specifying section 16b, the specification result of the vehicle state specifying section 16c, and the specification result of the operation input specifying section 16d. For example, in a case where the occupant in the vehicle is only the driver, the vehicle is traveling by manual driving, and an operation input is applied to the CID 11 or the like, the display control section 16e specifies case 1-1. For example, in a case where the occupants in the vehicle are the driver and the passenger, the vehicle is parked, the accessory is off, and a predetermined time elapses after the ignition is turned off, the display control section 16e specifies case 2-10.

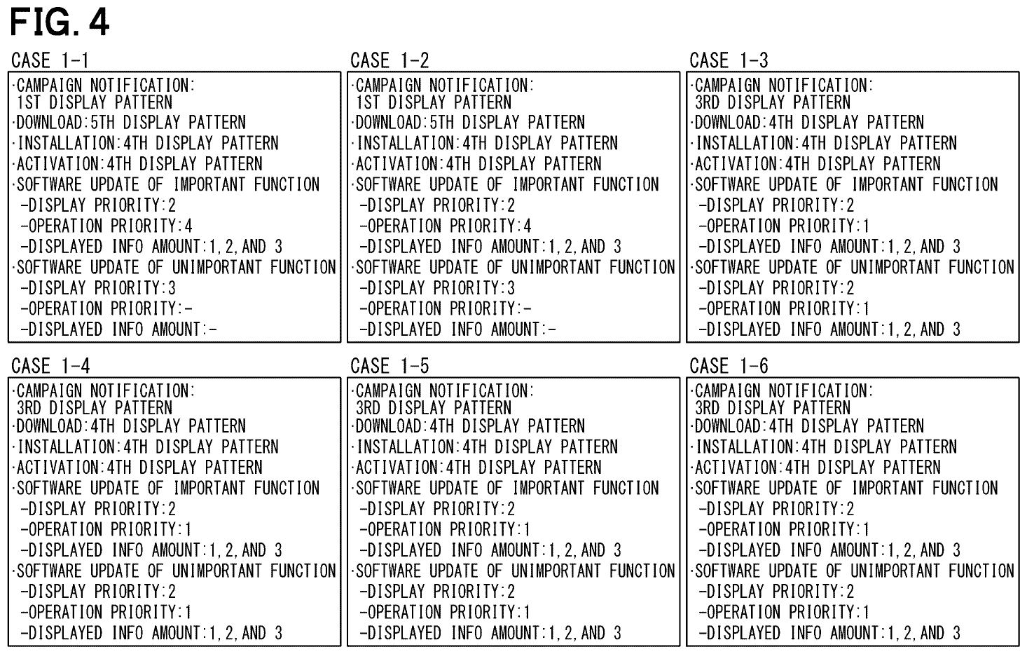

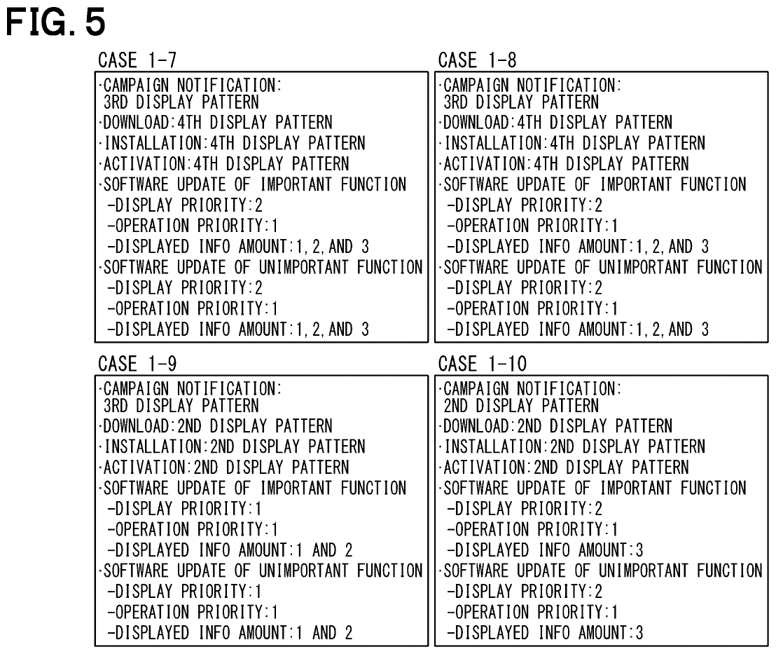

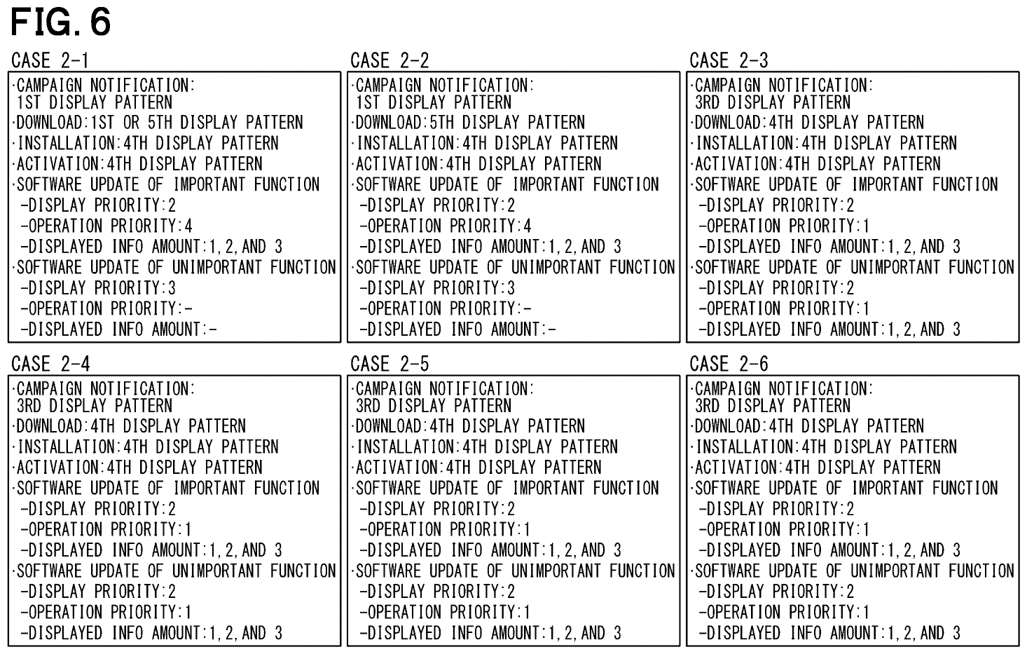

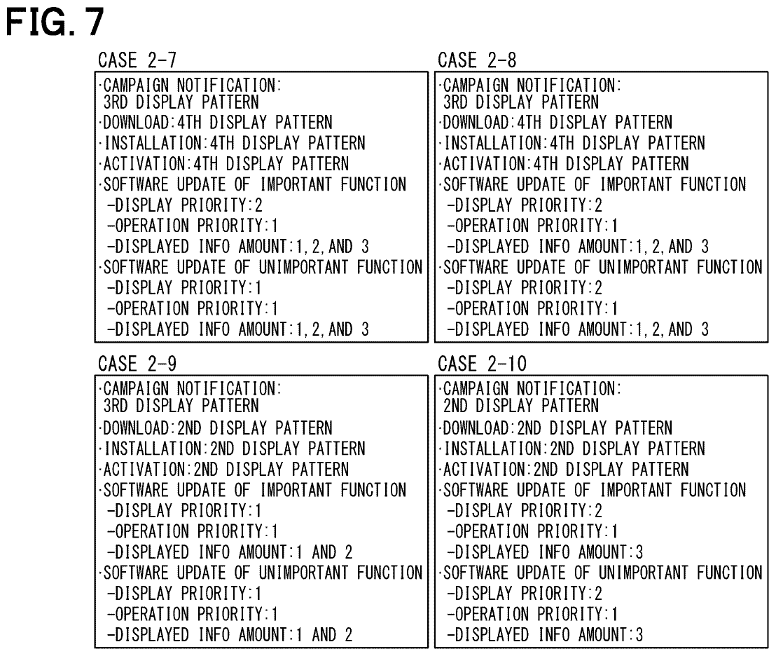

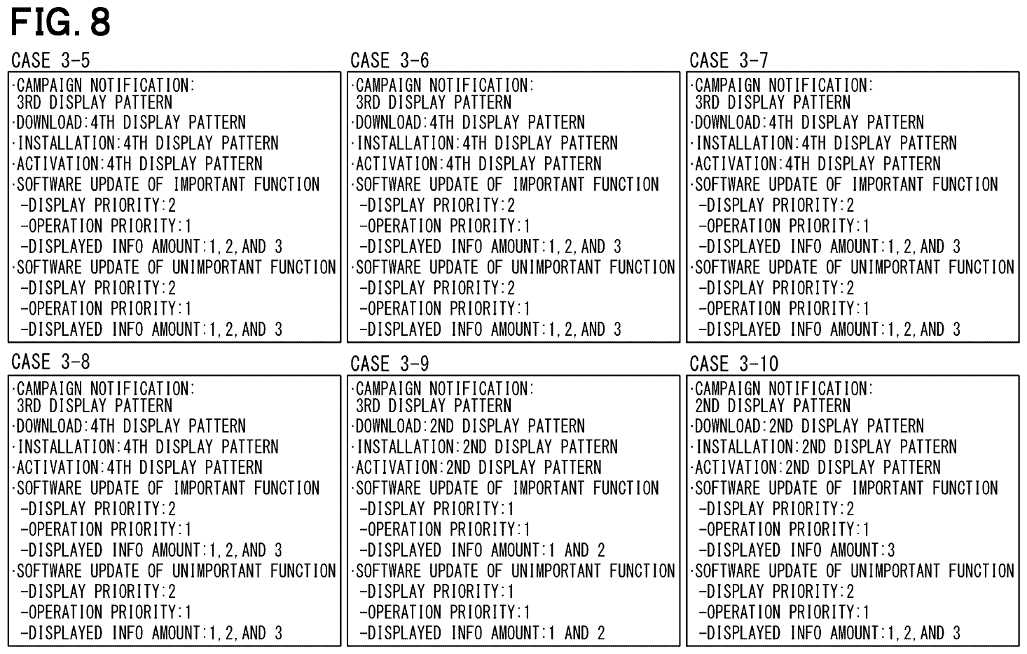

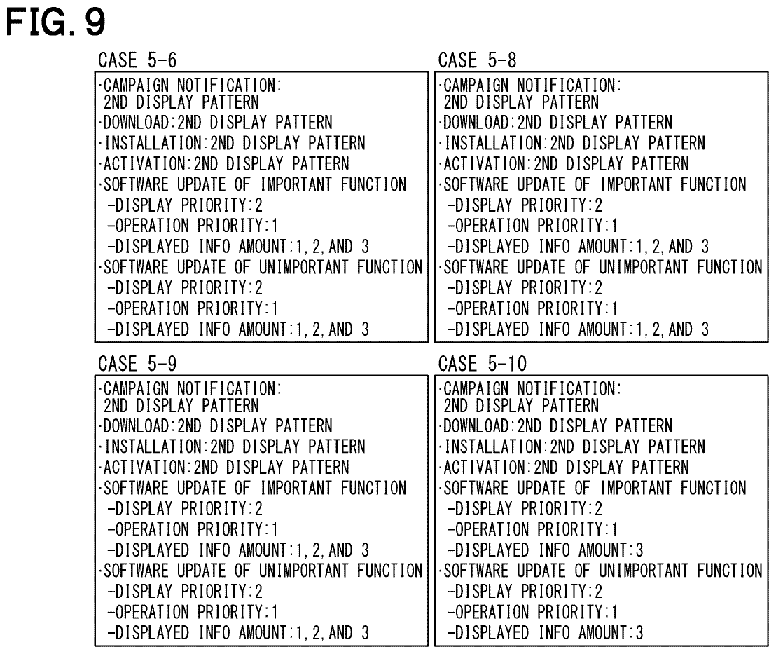

As illustrated in FIGS. 4 to 9, the display control section 16e predefines the content of the display mode of the update information for each of the cases classified by the case classification table. The content of the display mode of the update information includes display patterns in the campaign notification, download, installation, and activation phases, the display priority, the operation priority, and the displayed information amount in a case where the software update target is an important function, and the display priority, the operation priority, and the displayed information amount in a case where the software update target is an unimportant function.

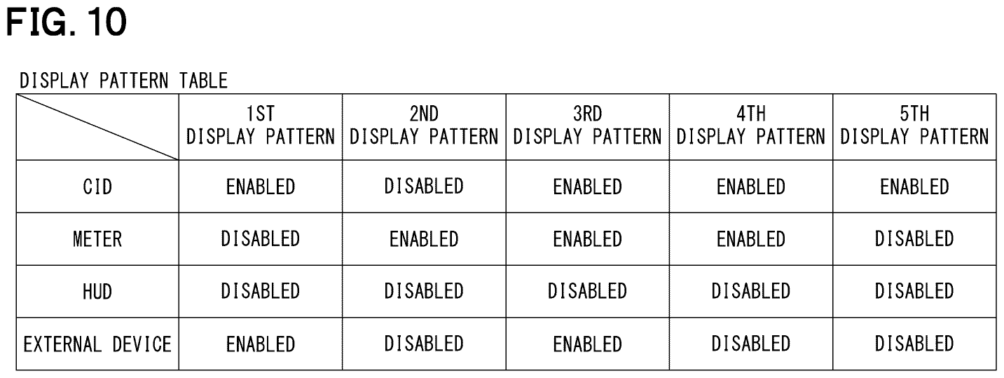

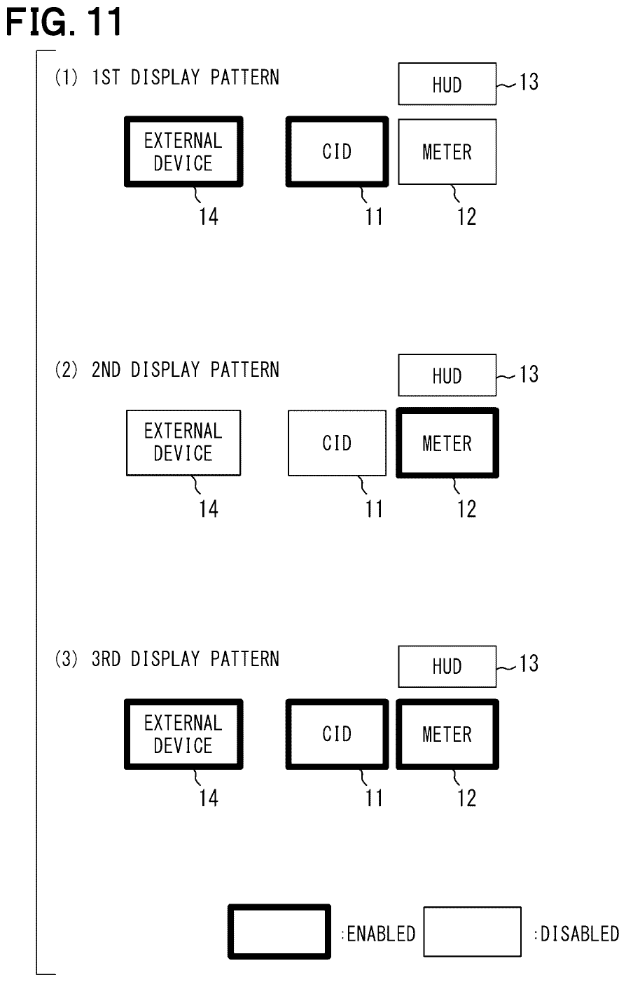

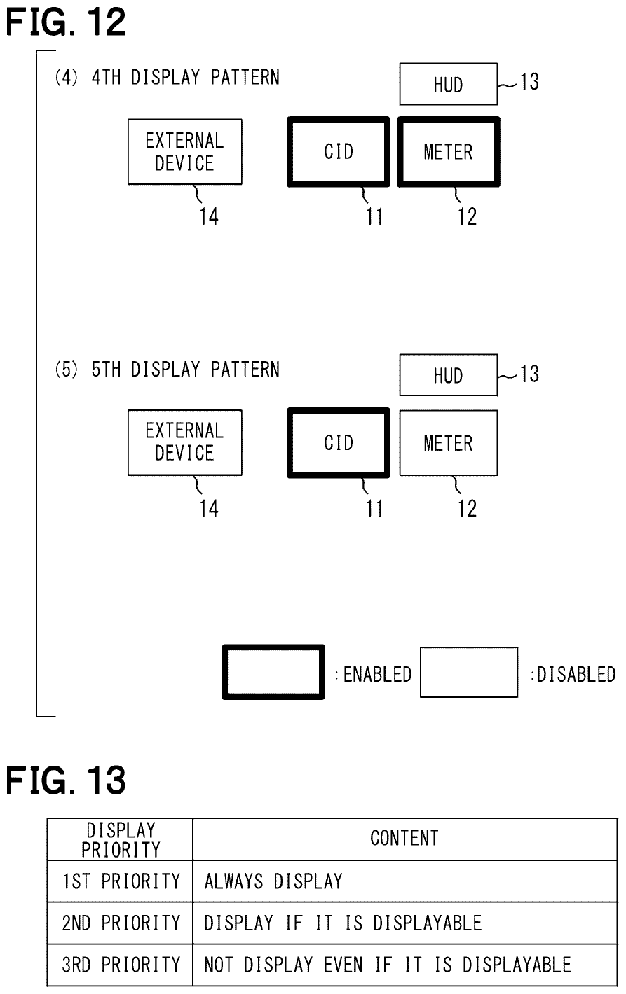

As illustrated in FIG. 10, the display control section 16e has a display pattern table indicating first to fifth display patterns as display patterns, and sets each corresponding device to either enabled or disabled. As illustrated in FIGS. 11 to 12, the first to fifth display patterns are enabled or disabled patterns of the CID 11, the meter device 12, the HUD 13, and the external device 14. The display control section 16e causes the device set to enabled to display the update information and does not cause the device set to disabled to display the update information. Since the display control section 16e sets a plurality of devices to enabled in the first, third, and fourth display patterns, the display control section 16e causes the plurality of devices to display the update information when the first, third, and fourth display patterns are selected.

As illustrated in FIG. 13, the display control section 16e sets one of first to third priorities as the display priority. The first priority means “always display”, the second priority means “display if it is displayable”, and the third priority means “not display even if it is displayable”.

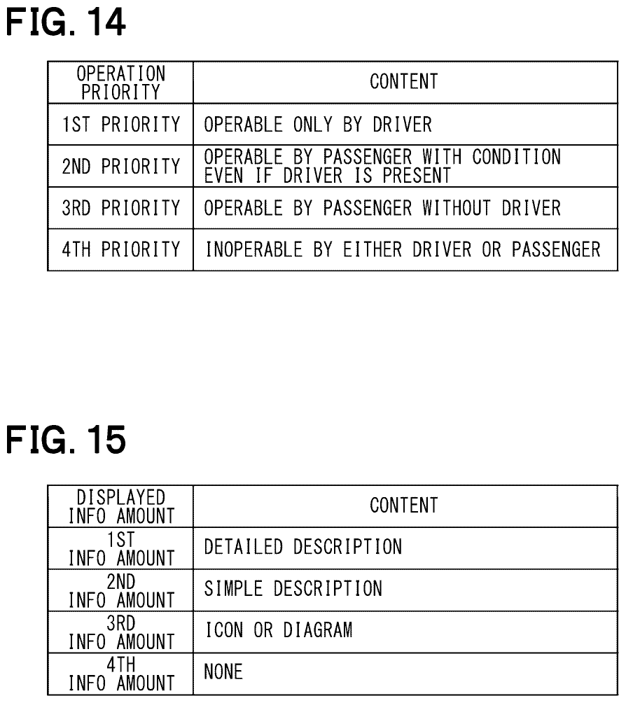

As illustrated in FIG. 14, the display control section 16e sets one of first to fourth priorities as the operation priority. The first priority means “operable only by driver”, the second priority means “operable by passenger with condition even if driver is present”, the third priority means “operable by passenger without driver (for example, purchased application or free application can be used)”, and the fourth priority means “inoperable by either driver or passenger”.

As illustrated in FIG. 15, the display control section 16e sets one of first to fourth information amounts as the displayed information amount. The first information amount means “detailed description”, the second information amount means “simple description”, the third information amount means “icon or diagram”, and the fourth information amount means “none”.

For example, in a case where the occupant in the vehicle is only the driver, the vehicle is traveling by manual driving, an operation input is applied to the CID 11 or the like, and thus case 1-1 is specified, the display control section 16e selects the first display pattern in the campaign notification phase, thereby setting the CID 11 and the external device 14 to enabled and setting the meter device 12 and the HUD 13 to disabled. That is, the display control section 16e causes the CID 11 and the external device 14 to display update information related to a campaign notification. The display control section 16e selects the fifth display pattern in the download phase, thereby setting the CID 11 to enabled, and setting the meter device 12, the HUD 13, and the external device 14 to disabled. That is, the display control section 16e causes the CID 11 to display update information related to download. The display control section 16e selects the fourth display pattern in the installation phase, thereby setting the CID 11 and the meter device 12 to enabled, and setting the HUD 13 and the external device 14 to disabled. That is, the display control section 16e causes the CID 11 and the meter device 12 to display update information related to installation. The display control section 16e selects the fourth display pattern in the activation phase, thereby setting the CID 11 and the meter device 12 to enabled, and setting the HUD 13 and the external device 14 to disabled. That is, the display control section 16e causes the CID 11 and the meter device 12 to display update information related to activation.

For example, in a case where case 1-1 is specified, if the software update target is an important function, the display control section 16e sets the display priority to the second priority, the operation priority to the fourth priority, and the displayed information amount to any one of the first to third information amounts. For example, in a case where case 1-1 is specified, if the software update target is an unimportant function, the display control section 16e sets the display priority to the third priority, and does not set the operation priority and the displayed information amount.

As described above, the display control section 16e specifies the corresponding case depending on the occupant state, the vehicle state, and the occupant's operation input, and displays the update information in accordance with the display mode predefined by the specified case.

For example, in a case where case 1-1 in which the vehicle is traveling by manual driving is compared with case 1-3 in which the vehicle is traveling by automated driving, for the download phase, the fifth display pattern is defined in case 1-1, whereas the fourth display pattern is defined in case 1-3. This is defined on the premises that there is a possibility that the display of the update information on the meter device 12 while the vehicle is traveling by manual driving hinders the driving operation of the driver, but no trouble occurs even if the update information is displayed on the meter device 12 while the vehicle is traveling by automated driving.

Similarly, for example, in a case where case 1-1 is compared with case 1-3, for the operation priority of the software update of the important function, the fourth priority is defined in case 1-1, whereas the first priority is defined in case 1-3. This is defined on the premises that there is a possibility that the driving operation of the driver is hindered if the operation is permitted while the vehicle is traveling by manual driving, but no trouble occurs even if the operation is permitted while the vehicle is traveling by automated driving.

For example, in a case where case 1-1 in which the vehicle is traveling by manual driving is compared with case 1-9 at the time of getting-off during parking, for the display priority of the software update of the important function, the second priority is defined in case 1-1, whereas the first priority is defined in case 1-9. This is defined with the intention that the display of the update information is not essential while the vehicle is traveling by manual driving, but the display of the update information is essential at the time of getting-off during parking.

For example, in a case where case 1-1 in which the vehicle is traveling by manual driving is compared with case 1-5 in which the vehicle is stopped, for the displayed information amount of the software update of the unimportant function, the information amount does not need to be defined in case 1-1, and the first, second, and third priorities may be defined in case 1-5. This is defined on the premises that there is a possibility that the driving operation of the driver is hindered if the information amount increased while the vehicle is traveling by manual driving, but no trouble occurs even if the information amount is increased while the vehicle is stopped.

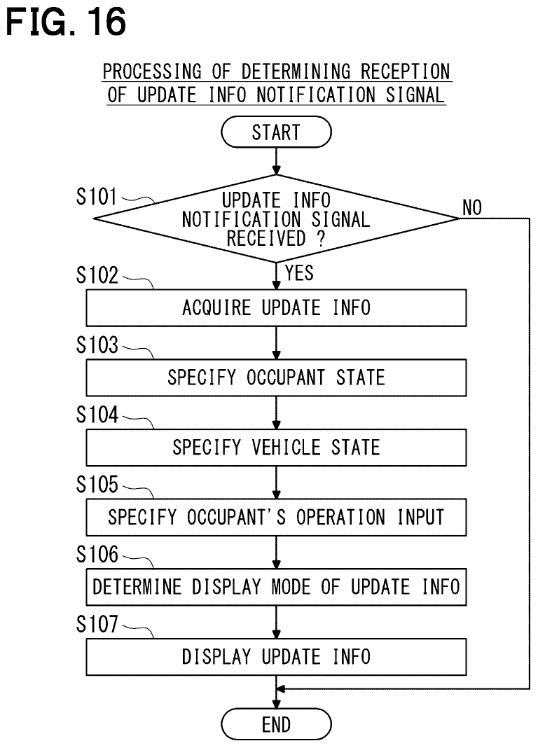

Next, the operation of the above configuration will be described with reference to FIGS. 16 to 31. Here, processing of determining the display mode of the update information on the basis of the specification result of the occupant state and the specification result of the vehicle state, processing of determining the display mode of the update information on the basis of the specification result of the operation input, and processing of displaying the update information when the vehicle power supply is turned off will be sequentially described.

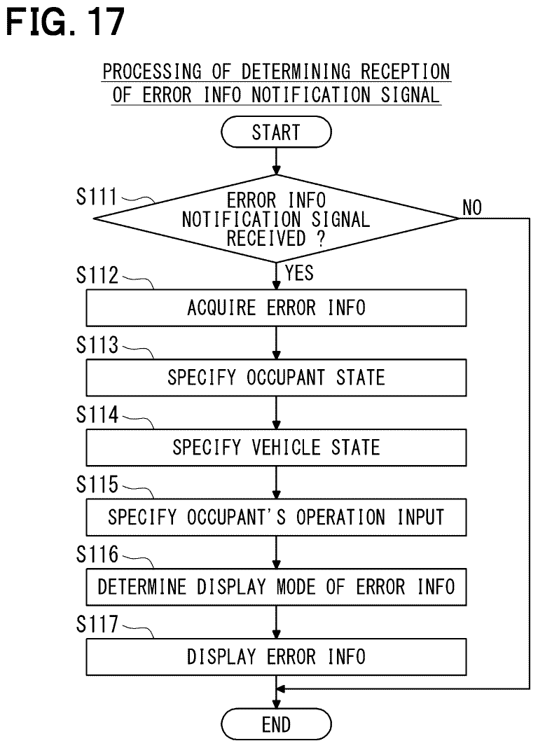

(1) Processing of determining display mode of update information on basis of specification result of occupant state and specification result of vehicle state (see FIGS. 16 to 17). Here, processing of determining reception of an update information notification signal and processing of determining reception of an error information notification signal will be sequentially described.

### (1-1) Processing of Determining Reception of Update Information Notification Signal (See FIG. 16)

The control section 16 performs the processing of determining reception of the update information notification signal at a predetermined cycle. When the processing of determining reception of the update information notification signal is started, the control section 16 determines whether or not the update information notification signal is received from the CGW 5 (S101). When determining that the update information notification signal is not received (S101: NO), the control section 16 terminates the processing of determining reception of the update information notification signal.

When determining that the update information notification signal is received (S101: YES), the control section 16 acquires update information on the basis of the received update information notification signal (S102, corresponding to “update information acquisition procedure”). The control section 16 specifies the occupant state on the basis of an occupant state notification signal (S103, corresponding to “occupant state specifying procedure”). The control section 16 specifies the vehicle state on the basis of a vehicle state notification signal (S104, corresponding to “vehicle state specifying procedure”). The control section 16 specifies the occupant's operation input on the basis of an operation input detection signal (S105, corresponding to “operation input specifying procedure”).

The control section 16 determines the display mode of the update information on the basis of the specification result of the occupant state, the specification result of the vehicle state, and the specification result of the occupant's operation input (S106, corresponding to “notification mode determination procedure”). That is, the control section 16 selects the corresponding case with reference to the case classification table illustrated in FIG. 3. When selecting the corresponding case, the control section 16 transmits a display instruction signal to the corresponding device in accordance with the selected case, causes the corresponding device to display the update information (S107, corresponding to “notification control procedure”), and terminates the processing of determining reception of the update information notification signal.

For example, in accordance with the case classification table illustrated in FIG. 3, the control section 16 specifies “only driver” as the specification result of the occupant state, specifies “vehicle is traveling by manual driving” as the specification result of the vehicle state, and specifies “operation input is applied” as the specification result of the occupant's operation input, thereby specifying case 1-1. In accordance with the display mode corresponding to case 1-1 illustrated in FIG. 4, for example, the control section 16 selects the first display pattern in the campaign notification phase and causes the CID 11 and the external device 14 to display update information related to a campaign notification. That is, the driver can check the update information related to the campaign notification with the CID 11 and the external device 14.

When the phase shifts from the campaign notification phase to the download phase, the control section 16 selects the fifth display pattern and causes the CID 11 to display update information related to download. That is, the driver can check the update information related to the download with the CID 11. When the phase shifts from the download phase to the installation phase, the control section 16 selects the fourth display pattern and causes the CID 11 and the meter device 12 to display update information related to installation. That is, the driver can check the update information related to the installation with the CID 11 and the meter device 12. When the phase shifts from the installation phase to the activation phase, the control section 16 continues the fourth display pattern and causes the CID 11 and the meter device 12 to display update information related to activation. That is, the driver can check the update information related to the activation with the CID 11 and the meter device 12.

The case where case 1-1 continues from the campaign notification phase to the activation phase has been exemplified above, but when the control section 16 specifies a change in occupant state, vehicle state, or occupant's operation input in the middle of the campaign notification phase to the activation phase, the control section selects a corresponding new case based on the change. The control section 16 transmits the display instruction signal to the corresponding device in accordance with the selected new case, and causes the corresponding device to display the update information. For example, when “only driver” is specified as the specification result of the occupant state, “stopped” is specified as the specification result of the vehicle state, and “operation input is applied” is specified as the specification result of the occupant's operation input, case 1-5 is newly specified. The control section 16 causes the corresponding device to display the update information in the display mode corresponding to case 1-5 illustrated in FIG. 4. That is, the control section 16 switches from case 1-1 to case 1-5 and causes the corresponding device to display the update information.

### (1-2) Processing of Determining Reception of Error Information Notification Signal (See FIG. 17)

The control section 16 performs the processing of determining reception of the error information notification signal at a predetermined cycle. When the processing of determining reception of the error information notification signal is started, the control section 16 determines whether or not the error information notification signal is received from the CGW 5 (S111). When determining that the error information notification signal is not received (S111: NO), the control section 16 terminates the processing of determining reception of the error information notification signal.

When determining that the error information notification signal is received (S111: YES), the control section 16 acquires error information on the basis of the received error information notification signal (S112). The control section 16 specifies the occupant state on the basis of the occupant state notification signal (S113). The control section 16 specifies the vehicle state on the basis of the vehicle state notification signal (S114). The control section 16 specifies the occupant's operation input on the basis of the operation input detection signal (S115).

The control section 16 determines the display mode of the error information on the basis of the specification result of the occupant state, the specification result of the vehicle state, and the specification result of the occupant's operation input (S116). That is, the control section 16 selects the corresponding case with reference to the case classification table illustrated in FIG. 3. When selecting the corresponding case, the control section 16 transmits the display instruction signal to the corresponding device in accordance with the selected case, causes the corresponding device to display the error information (S117), and terminates the processing of determining reception of the error information notification signal.

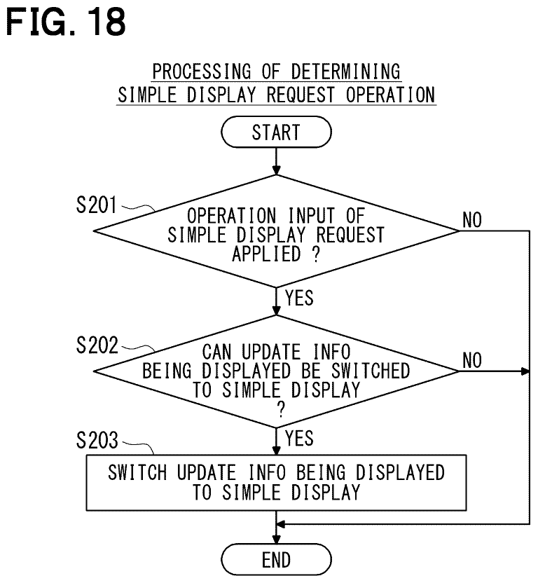

(2) Processing of determining display mode of update information on basis of specification result of operation input (see FIGS. 18 to 29). Here, processing of determining a simple display request operation, processing of determining a detailed display request operation, and processing of determining a cancel request operation will be sequentially described.

### (2-1) Processing of Determining Simple Display Request Operation (See FIGS. 18 to 22)

For example, a driver who desires to simply display the update information performs an operation input of a simple display request. The control section 16 performs the processing of determining the simple display request operation at a predetermined cycle while the update information is being displayed. When the processing of determining the simple display request operation is started, the control section 16 determines whether or not the operation input of the simple display request is applied by an operation input detection signal from the operation input portion 15 (S201). When determining that the operation input of the simple display request is not applied (S201: NO), the control section 16 terminates the processing of determining the simple display request operation.

When determining that the operation input of the simple display request is applied (S201: YES), the control section 16 determines whether or not the update information being displayed can be switched to the simple display (S202). When determining that the update information being displayed cannot be switched to the simplified display (S202: NO), the control section 16 terminates the processing of determining the simple display request operation without switching the update information being displayed to the simple display. When determining that the update information being displayed can be switched to the simplified display (S202: YES), the control section 16 switches the update information being displayed to the simple display (S203), and terminates the processing of determining the simple display request operation.

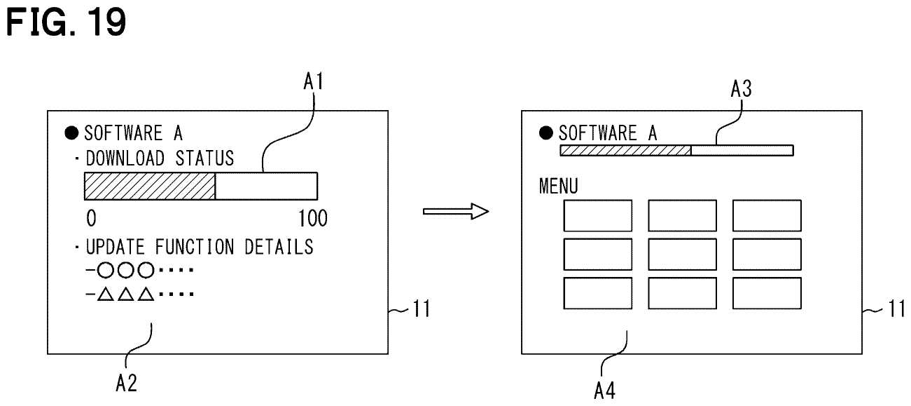

As illustrated in FIG. 19, for example, when determining that it is possible to switch to the simple display while a progress bar A1 as a download status and a function description A2 as update function details are being displayed on the CID 11 as the update information, the control section 16 switches to a screen that displays only a progress bar A3 as the update information and displays a menu button group A4 as information unrelated to the update information. The information unrelated to the update information may be other than the menu button group A4, and may be for example, a map used for a navigation function, a camera image from a parking assist function, audio information related to audio, air conditioning information related to air conditioning, or the like.

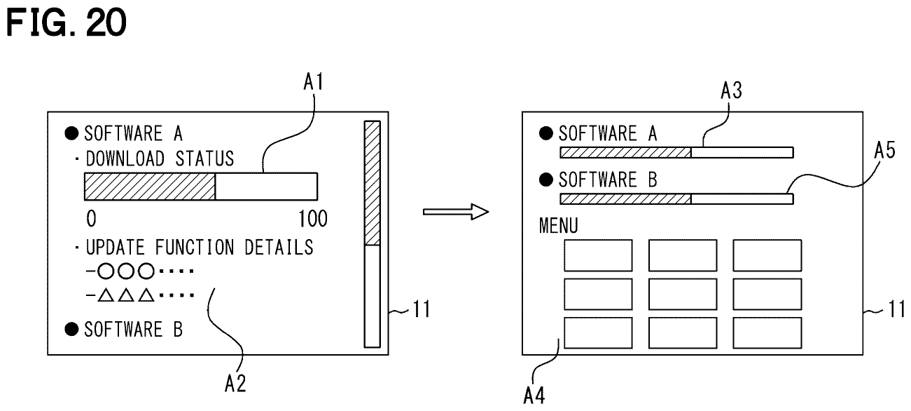

As illustrated in FIG. 20, the same applies to a case where there are a plurality of update software, and the control section 16 switches to a screen that displays, for the individual update software, only the progress bars A3 and A5 as the update information and displays the menu button group A4.

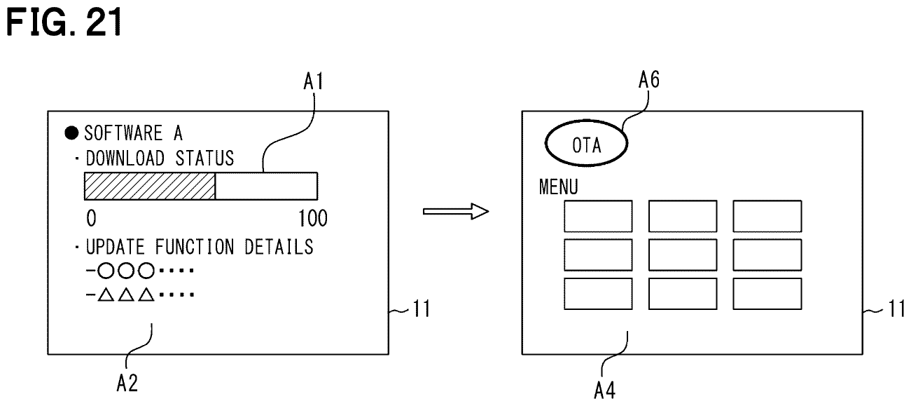

As illustrated in FIG. 21, the control section 16 may switch to a screen that displays an updating button A6 as the update information in a blinking manner instead of the progress bar A3 and displays the menu button group A4.

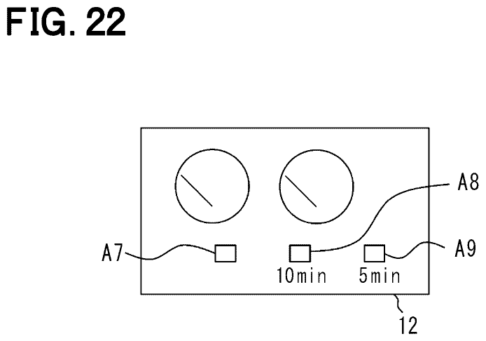

As illustrated in FIG. 22, the control section 16 may cause the meter device 12 to display indicators A7 to A9, and may cause the indicators A8 and A9 each corresponding to a function for which the software is being updated to display the remaining time until the software update is completed.

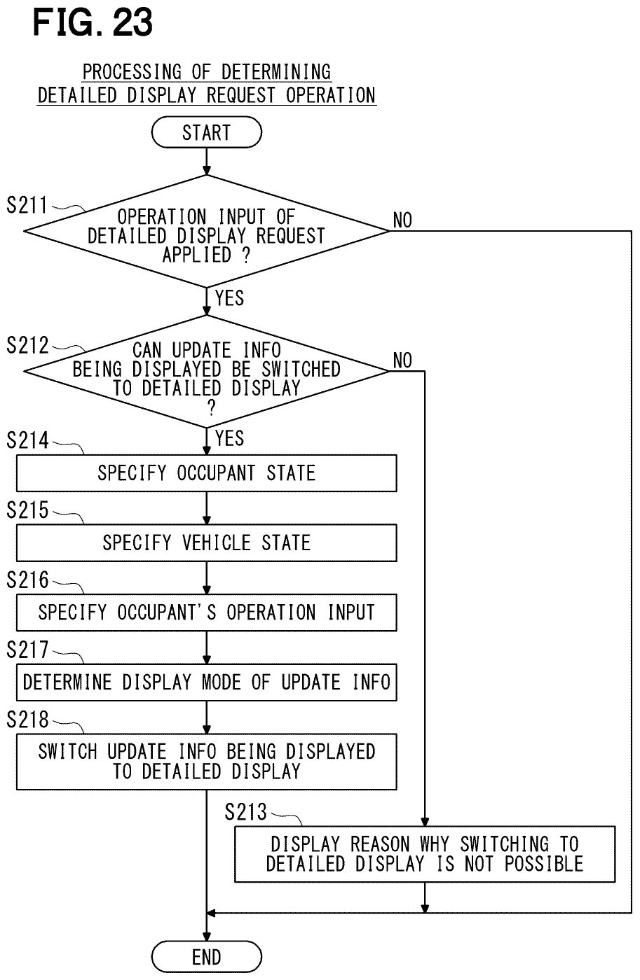

### (2-2) Processing of Determining Detailed Display Request Operation (See FIGS. 23 to 25)

For example, a driver who desires to display details of the update information performs an operation input of a detailed display request. The control section 16 performs the processing of determining the detailed display request operation at a predetermined cycle while the update information is being displayed. When the processing of determining the detailed display request operation is started, the control section 16 determines whether or not the operation input of the detailed display request is applied by an operation input detection signal from the operation input portion 15 (S211). When determining that the operation input of the detailed display request is not applied (S211: NO), the control section 16 terminates the processing of determining the detailed display request operation.

When determining that the operation input of the detailed display request is applied (S211: YES), the control section 16 determines whether or not the update information being displayed can be switched to the detailed display (S212). When determining that the update information being displayed cannot be switched to the detailed display (S212: NO), the control section 16 displays a message indicating the reason why switching to the detailed display is not possible without switching the update information being displayed to the detailed display (S213), and terminates the processing of determining the detailed display request operation.

When determining that the update information being displayed can be switched to the detailed display (S212: YES), the control section 16 specifies the occupant state on the basis of the occupant state notification signal (S214), specifies the vehicle state on the basis of the vehicle state notification signal (S215), specifies the occupant's operation input on the basis of the operation input detection signal (S216), and determines the display mode of the update information on the basis of the specification result of the occupant state, the specification result of the vehicle state, and the specification result of the occupant's operation input (S217). The control section 16 switches the update information being displayed to the detailed display in accordance with the determined display mode (S218), and terminates the processing of determining the detailed display request operation.

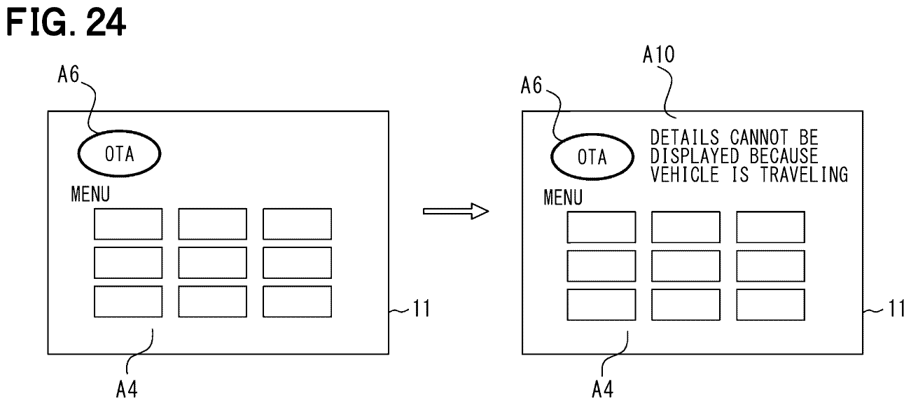

As illustrated in FIG. 24, when determining that it is impossible to switch to the detailed display while the updating button A6 is being displayed as the update information and the menu button group A4 is being displayed on the CID 11, the control section 16 does not switch the update information being displayed to the detailed display and displays a message A10 of “Details cannot be displayed because vehicle is traveling” indicating the reason why switching to the detailed display is not possible.

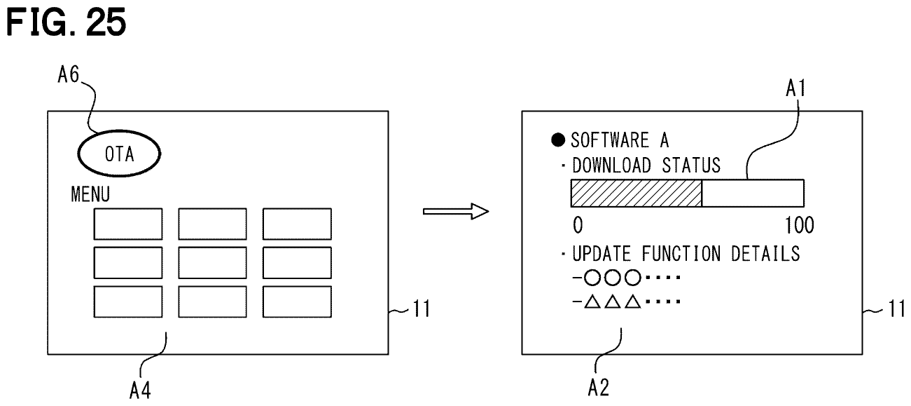

As illustrated in FIG. 25, for example, when determining that it is possible to switch to the detailed display while the updating button A6 as the update function is being displayed and the menu button group A4 is being displayed on the CID 11, the control section 16 switches to a screen that displays, as the update information, the progress bar A1 as the download status and displays the function description A2 as the update function details.

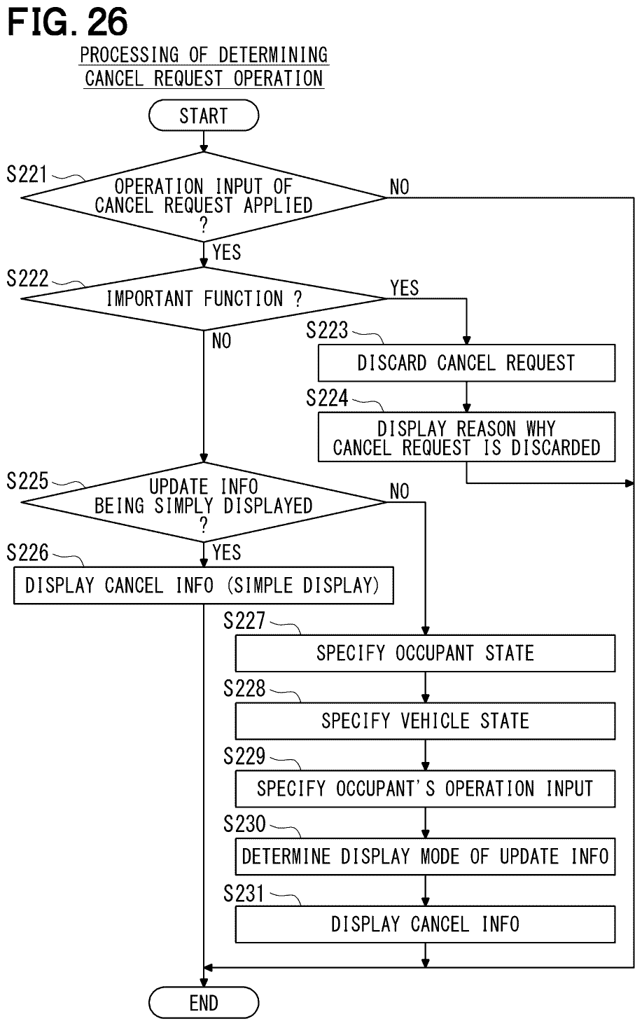

### (2-3) Processing of Determining Cancel Request Operation (See FIGS. 26 to 29)

For example, a driver who desires to cancel the software update performs an operation input of a cancel request. The control section 16 performs the processing of determining the cancel request operation at a predetermined cycle while the update information is being displayed. When the processing of determining the cancel request operation is started, the control section 16 determines whether or not the operation input of the cancel request is applied by an operation input detection signal from the operation input portion 15 (S221). When determining that the operation input of the cancel request is not applied (S221: NO), the control section 16 terminates the processing of determining the cancel request operation.

When determining that the operation input of the cancel request is applied (S221: YES), the control section 16 determines whether or not the cancel request target is an important function (S222). When determining that the operation input of the cancel request is applied (S221: YES), the control section 16 determines whether or not the cancel request target to be software-updated is an important function (S222).

When determining that the cancel request target to be software-updated is an important function (S222: YES), the control section 16 discards the cancel request (S223). The control section 16 displays a message indicating the reason why the cancel request is discarded (S224), and terminates the processing of determining the cancel request operation.

When determining that the cancel request target to be software-updated is not an important function (S222: NO), the control section 16 determines whether or not the update information is being simply displayed (S225). When determining that the update information is being simply displayed (S225: YES), the control section 16 causes the corresponding device to display cancel information indicating the cancellation of the software update (S226), and terminates the processing of determining the cancel request operation.

When determining that the update information is not being simply displayed (S225: NO), the control section 16 specifies the occupant state on the basis of the occupant state notification signal (S227), specifies the vehicle state on the basis of the vehicle state notification signal (S228), specifies the occupant's operation input on the basis of the operation input detection signal (S229), and determines the display mode of the update information on the basis of the specification result of the occupant state, the specification result of the vehicle state, and the specification result of the occupant's operation input (S230). The control section 16 causes the corresponding device to display the cancel information indicating the cancellation of the software update in accordance with the determined display mode (S231), and terminates the processing of determining the cancel request operation. In this case, the control section 16 displays details of the cancel information if the details can be displayed on the basis of the specification result of the occupant state, the specification result of the vehicle state, and the specification result of the occupant's operation input, and simply displays the cancel information if the details cannot be displayed.

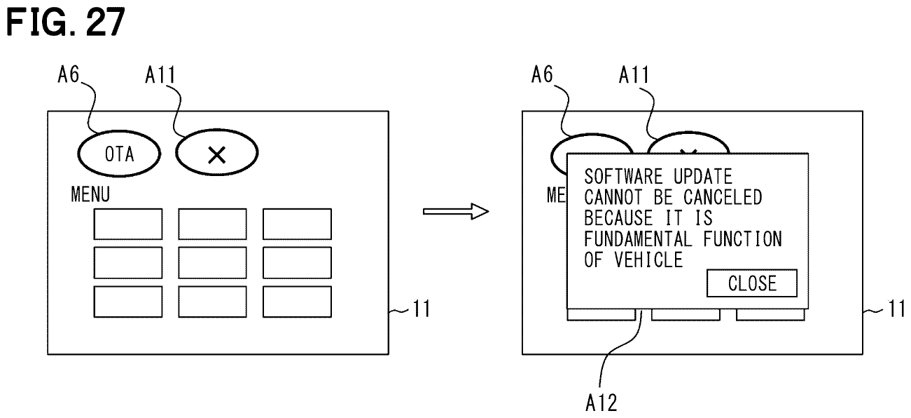

As illustrated in FIG. 27, for example, when determining that the operation input of a cancel button A11 is applied and that the cancel request target to be software-updated is an important function, the control section 16 discards the cancel request and displays a pop-up message A12 “Software update cannot be canceled because it is fundamental function of vehicle” indicating the reason why the cancel request is discarded.

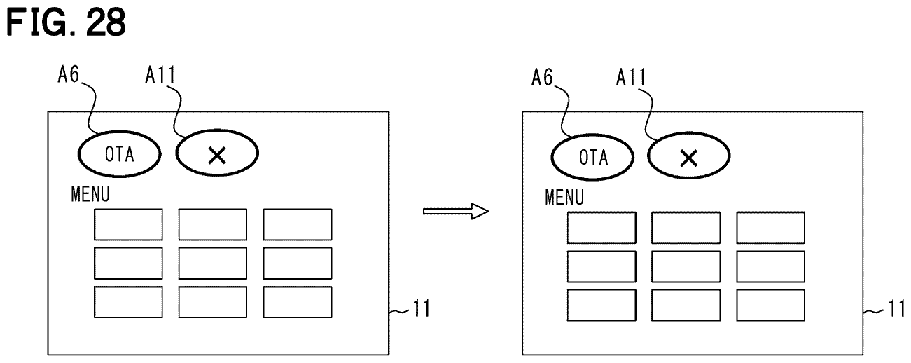

As illustrated in FIG. 28, when determining that the update information is being simply displayed, the control section 16 causes the corresponding device to display the cancel information indicating the cancellation of the software update. For example, the control section 16 displays the cancel information by graying out the updating button A6.

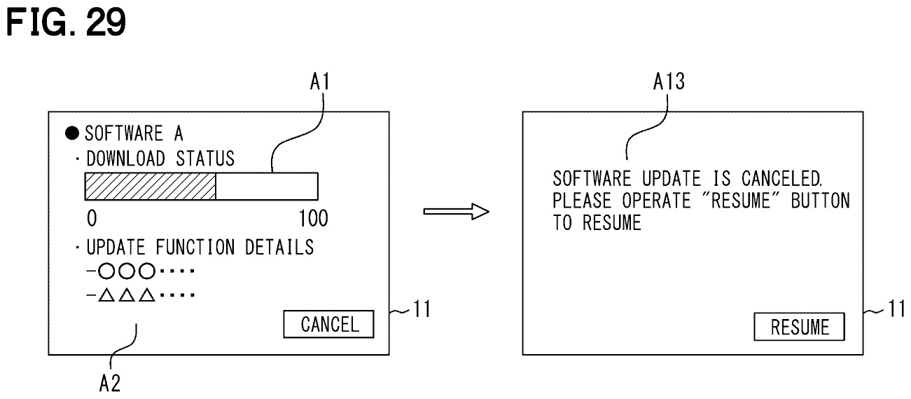

As illustrated in FIG. 29, when determining that the update information is not being simply displayed, the control section 16 determines the display mode of the update information on the basis of the specification result of the occupant state, the specification result of the vehicle state, and the specification result of the occupant's operation input, and causes the corresponding device to display the cancel information indicating the cancellation of the software update in accordance with the determined display mode. The control section 16 displays a message A13 of “Software update is canceled. Please operate “resume” button to resume” indicating that the software update is canceled.

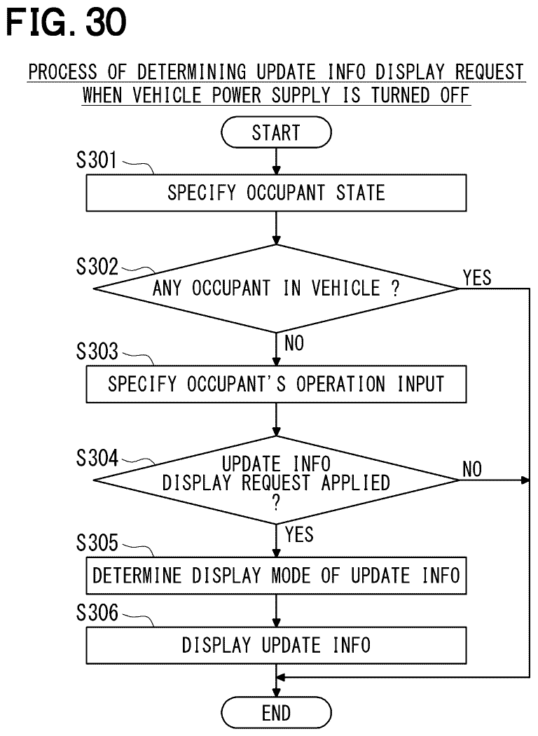

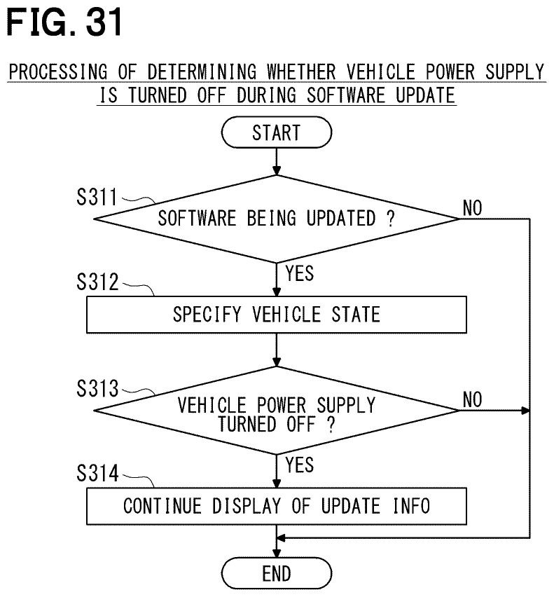

(3) Processing of displaying update information when vehicle power supply is turned off (see FIGS. 30 to 31). Here, processing of determining an update information display request when the vehicle power supply is turned off and processing of determining whether the vehicle power supply is turned off during a software update will be sequentially described.

### (3-1) Process of Determining Update Information Display Request When Vehicle Power Supply is Turned Off

The control section 16 performs the processing of determining the update information display request when the vehicle power supply is turned off at a predetermined cycle. When the processing of determining the update information display request is started, the control section 16 specifies the occupant state on the basis of an occupant state notification signal (S301), and determines whether or not there is an occupant in the vehicle (S302). When determining that there is an occupant in the vehicle (S302: YES), the control section 16 terminates the processing of determining the update information display request when the vehicle power supply is turned off.

When determining that there is no occupant in the vehicle, that is, when determining that no occupant is present in the vehicle (S302: NO), the control section 16 specifies the occupant's operation input on the basis of the operation input detection signal (S303), and determines whether or not the operation input indicating the update information display request is applied (S304). When it is determined that the operation input indicating the update information display request is not applied (S304: NO), the processing of determining the update information display request when the vehicle power supply is turned off terminates.

When determining that the operation input indicating the update information display request is applied (S304: YES), the control section 16 determines the display mode of the update information on the basis of the specification result of the occupant state and the specification result of the occupant's operation input (S305). The control section 16 causes the corresponding device to display the update information in accordance with the determined display mode (S306), and terminates the processing of determining the update information display request when the vehicle power supply is turned off.

### (3-2) Processing of Determining Whether Vehicle Power Supply is Turned Off During Software Update

The control section 16 performs the processing of determining whether the vehicle power supply is turned off during the software update at a predetermined cycle. When the processing of determining whether the vehicle power supply is turned off during the software update is started, the control section 16 determines whether or not the software is being updated (S311). When determining that the software is not being updated (S311: NO), the control section 16 terminates the processing of determining whether the vehicle power supply is turned off during the software update.

When determining that the software is being updated (S311: YES), the control section 16 specifies the vehicle state on the basis of the vehicle state notification signal (S312), and determines whether or not the vehicle power supply is turned off (S313). When determining that the vehicle power supply is not turned off (S313: NO), the control section 16 terminates the processing of determining whether the vehicle power supply is turned off during the software update.

When determining that the vehicle power supply is turned off (S313: YES), the control section 16 continues the display of the update information (S314), and terminates the processing of determining whether the vehicle power supply is turned off during the software update.

Although the configuration in which the update information acquisition section 16a, the occupant state specifying section 16b, the vehicle state specifying section 16c, the operation input specifying section 16d, and the display control section 16e are arranged in the HCU 7 has been described above, the functions of the sections 16a to 16e may be distributed and arranged in different devices. For example, the ECU that specifies the occupant state, the ECU that specifies the vehicle state, and the ECU that specifies the occupant's operation input may be separately arranged, and these ECUs may transmit specification results to the HCU 7. Alternatively, the functions of the sections 16a to 16e may be arranged in the CGW 5.

According to the present embodiment described above, the following operational effects can be obtained. In the HCU 7, the display mode of the update information is determined on the basis of the specification result of the occupant state and the specification result of the vehicle state, and the update information is displayed in accordance with the determined display mode. The update information is not displayed in a uniform display mode of the update information, but the update information is displayed by determining the display mode of the update information on the basis of the occupant state and the vehicle state, so that the update information related to the software update can be appropriately displayed depending on scenes.

For example, in a case where the update information is displayed while the vehicle is traveling, there is a possibility that the driver's attention is attracted if the update information is displayed in a detailed display mode. However, by reducing the information amount and displaying the update information in a simple display mode, the attraction of the driver's attention can be avoided in advance. For example, in a case where the update information is displayed during parking, if the information amount is increased and the update information is displayed in a detailed display mode, there is a possibility that electric power of the vehicle battery is unnecessarily consumed. However, by displaying the update information in the simple display mode, unnecessary electric power consumption of the vehicle battery can be avoided in advance.

The status of progress of the software update is displayed as the update information. For example, in the download phase, it is possible to appropriately display information indicating the start of download, information indicating the execution of download, information such as a numerical value indicating, in percentage, the amount of data that has been downloaded with respect to the amount of data scheduled to be downloaded as the progress of download, information notifying the reason for suspension when download is suspended for some reason, information indicating the completion of download, and the like.

The function to be restricted in use during the software update is displayed as the update information. For example, when software related to travel control is being updated, the function to be restricted in use related to the travel control can be displayed. In this case, by displaying the function to be restricted in use during the software update with icon display, the function to be restricted in use can be simply displayed.

Whether the vehicle is traveling, stopped, or parked is specified as the vehicle state, and the display mode of the update information is determined on the basis of whether the vehicle is traveling, stopped, or parked. The display mode of the update information can be appropriately determined depending on whether the vehicle is traveling, stopped, or parked, and the update information can be appropriately displayed depending on whether the vehicle is traveling, stopped, or parked.

Whether the vehicle is traveling by manual driving or the vehicle is traveling by automated driving is specified as the vehicle state, and the display mode of the update information is determined on the basis of whether the vehicle is traveling by manual driving or the vehicle is traveling by automated driving. The display mode of the update information can be appropriately determined depending on whether the vehicle is traveling by manual driving or the vehicle is traveling by automated driving, and the update information can be appropriately displayed depending on whether the vehicle is traveling by manual driving or the vehicle is traveling by automated driving.

Any of a plurality of display devices is determined as the display mode of the update information. By selecting an appropriate display device among a plurality of display devices having different arrangement positions and display sizes, the update information can be appropriately displayed.

The displayed information amount is determined as the display mode of the update information. The update information can be displayed with an appropriate displayed information amount.

The present disclosure has been described in accordance with exemplary embodiments. However, it is to be understood that the disclosure is not limited to such embodiments or structures. The present disclosure also encompasses various modifications and alterations within the scope of equivalents. In addition, various combinations and configurations, as well as other combinations and configurations including only one element, more than one element, or fewer elements than those described, are also within the scope and spirit of the present disclosure.

The control unit and methods described in the present disclosure may be implemented by a dedicated computer provided by configuring a processor and memory programmed to execute one or more functions embodied by a computer program. Alternatively, the control unit and methods described in the present disclosure may be implemented by a dedicated computer provided by configuring a processor with one or more dedicated hardware logic circuits. Alternatively, the control unit and methods described in the present disclosure may be implemented by one or more dedicated computers configured by a combination of a processor and memory programmed to execute one or more functions and a processor configured with one or more hardware logic circuits. Furthermore, the computer program may be stored as instructions executable by a computer on a computer-readable non-transitory tangible recording medium.

What is claimed is:

1. An update information notification device that causes a notification device to notify update information related to a software update when software of an electronic control device to be updated is updated by update software acquired from a distribution device, the update information notification device comprising:
at least one of (i) a circuit and (ii) a processor with a memory storing computer program code executable by the processor, the at least one of the circuit and the processor configured to cause the update information notification device to:
acquire the update information;
specify an occupant state indicating a state of an occupant;
specify a vehicle state indicating a state of a vehicle; and
determine a notification mode of the update information and cause the notification device to notify the update information in accordance with a determined notification mode,
wherein
a notification mode of the update information is determined based on a case classified according to a combination of a specified occupant state and a specified vehicle state.

2. The update information notification device according to claim 1, wherein
an update information acquisition section is implemented by the at least one of the circuit and the processor configured to acquire the update information;
an occupant state specifying section is implemented by the at least one of the circuit and the processor configured to specify an occupant state indicating a state of an occupant;
a vehicle state specifying section is implemented by the at least one of the circuit and the processor configured to specify a vehicle state indicating a state of a vehicle; and
a notification control section is implemented by the at least one of the circuit and the processor configured to determine a notification mode of the update information and cause the notification device to notify the update information in accordance with a determined notification mode,
wherein
the notification control section determines a notification mode of the update information based on a case classified according to a combination of the occupant state specified by the occupant state specifying section and the vehicle state specified by the vehicle state specifying section.

3. The update information notification device according to claim 2, wherein
the notification control section causes the notification device to notify, as the update information, a progress of a software update.

4. The update information notification device according to claim 2, wherein
the notification control section causes the notification device to notify, as the update information, a function subject to use restriction during a software update.

5. The update information notification device according to claim 4, wherein
the notification control section causes the notification device to notify, as the update information, a function subject to use restriction during a software update in a form of an icon display.

6. The update information notification device according to claim 2, wherein
the vehicle state specifying section specifies, as the vehicle state, whether the vehicle is traveling, stopped, or parked, and
the notification control section determines a notification mode of the update information based on whether the vehicle is traveling, stopped, or parked as a result specified by the vehicle state specifying section.

7. The update information notification device according to claim 2, wherein
the vehicle state specifying section specifies, as the vehicle state, whether the vehicle is traveling by manual driving or by automated driving, and
the notification control section determines a notification mode of the update information based on whether the vehicle is traveling by manual driving or the vehicle is traveling by automated driving as a result specified by the vehicle state specifying section.

8. The update information notification device according to claim 2, wherein
the notification control section determines any of a plurality of notification devices as a notification mode of the update information.

9. The update information notification device according to claim 2, wherein
the notification control section determines amount of information to be notified as a notification mode of the update information.

10. The update information notification device according to claim 2, wherein
the notification control section determines the notification mode of the update information such that, when the vehicle state specifying section specifies that the vehicle is traveling, amount of information to be notified is less than when the vehicle state specifying section specifies that the vehicle is stopped.

11. The update information notification device according to claim 2, wherein
the notification control section determines a plurality of notification devices as a notification mode of the update information in a case where the occupant state specifying section specifies that there are a plurality of occupants.

12. A vehicle system comprising:
a notification device configured to notify update information related to a software update when software of an electronic control device to be updated is updated by update software acquired from a distribution device; and
an update information notification device configured to cause the notification device to notify the update information,
wherein
the update information notification device includes
an update information acquisition section that acquires the update information,
an occupant state specifying section that specifies an occupant state indicating a state of an occupant,
a vehicle state specifying section that specifies a vehicle state indicating a state of a vehicle, and
a notification control section that determines a notification mode of the update information and causes the notification device to notify the update information in accordance with a determined notification mode, and
the notification control section determines a notification mode of the update information based on a case classified according to a combination of the occupant state specified by the occupant state specifying section and the vehicle state specified by the vehicle state specifying section.

13. A non-transitory computer readable storage medium storing an update information notification program that causes a control section of an update information notification device that causes a notification device to notify update information related to a software update when software of an electronic control device to be updated is updated by update software acquired from a distribution device to perform:
acquiring the update information;
specifying an occupant state indicating a state of an occupant;
specifying a vehicle state indicating a state of a vehicle;
determining a notification mode of the update information based on a case classified according to a combination of the occupant state specified and the vehicle state specified; and
causing the notification device to notify the update information in accordance with the notification mode determined.
